(19) United States
(12) Patent Application Publication
(10) Pub. No.: US 2005/0067229 A1
(43) Pub. Date: Mar. 31, 2005

(54) Gasket seal for wheel assembly

(76) Inventor: Gerald E. Gabourie, Orillia (CA)

Correspondence Address: BAKER & DANIELS;111 E. WAYNE STREET, SUITE 800, FORT WAYNE, IN, 46802, US

(21) Appl. No.: 10/674,021

(22) Filed: Sep. 29, 2003

(51) Int. Cl. F16J 3/00

(52) U.S. Cl. 188/71.1; 277/628

(57) ABSTRACT

A gasket device for use on a brake drum or wheel hub comprises an annular, flat gasket seal made of flexible polyethylene. One embodiment has a circular outer periphery with a diameter corresponding to the diameter of an annular attachment surface of the drum or hub. This seal has a circular central opening with a diameter corresponding to that of a central, cylindrical extension adjacent the drum or hub. A plurality of small openings readily accommodate wheel studs on the drum or hub. The first embodiment is mounted between the drum or hub and a central mounting portion of the vehicle wheel. This seal prevents bonding of the wheel to the attachment surface as a result of corrosion. In a second embodiment, the outer periphery of the gasket seal has a diameter corresponding to an outer diameter of a hub flange in the brake and wheel assembly. This second version is mounted between an annular attachment surface of the assembly and an inner surface of the drum.

### BACKGROUND OF THE INVENTION

This invention relates to gaskets and seals and, in particular, to such devices intended for use with wheel brakes, including drum brakes, and wheel assemblies.

Gaskets or gasket seals are widely known for a variety of purposes. In general terms, a gasket is a thin sheet of rubber, metal or other material that is placed between two flat surfaces to seal the joint. One well known form of gasket is commonly used between the cylinder block and the cylinder head in a car engine.

Canadian Patent Application No. 2,119,637 published Mar. 2, 1994, teaches an arrangement which is said to prevent contact erosion in a magnesium wheel. In this known arrangement, an annular aluminium washer is inserted between the inner contact face of the magnesium wheel and the wheel mounting face in the region of the stud bores. This arrangement also requires a centering device in the form of an annular, plastics adaptor that is squeezed into the hub bore of the magnesium wheel and that covers the radially inner circumferential face of the washer. It is believed that this known system cannot prevent corrosion entirely since there exists a possibility of corrosion between the aluminium washer and the magnesium wheel. Also, because of the number of components and their relative complexity, it is believed that this solution for preventing corrosion is not particularly cost effective.

Published PCT application No. WO98/38048 dated Feb. 24, 1998 describes a magnesium alloy wheel provided with a so-called waterproofing structure, including a seal ring provided on a member which is connected to a center hole of the wheel. There is a liner to prevent contact corrosion between the different metals, this liner being applied to a hub flange and the attachment face of the wheel. This system also employs a flange washer which is recessed on one side and which has the characteristic of small contact potential difference with respect to magnesium. This washer fits under a wheel nut that is used to fasten the wheel to a rim. This wheel protection system has a number of different components and therefore this system also may not be cost effective.

Published European Patent Application No. 081181 describes a wheel disk intended for use with the wheel of a commercial vehicle, for example, between the dual wheels of a commercial vehicle. This disk has bolt holes in the region of the wheel mounting face for attaching the wheel disk to a wheel hub flange or possibly to a brake drum by way of wheel bolts. The holes in this known plastic disk are sized to fit only loosely around the wheel studs and around the inner hub of the truck wheels. It is believed that this wheel disk does not conform its shape to an adjacent face of the central mounting portion of the wheel. It therefore does not appear that this known form of wheel disk is very efficient at preventing corrosion at the attachment surface where the wheel is mounted to a brake or wheel assembly.

It is an object of one aspect of the present invention to provide an inexpensive gasket device for use on a brake drum or wheel hub that can be mounted in a sealing manner between the brake drum or hub and a central mounting portion of a vehicle wheel and thereby prevents bonding of a steel or alloy wheel caused by corrosion.

It is a further object of another aspect of the invention to provide a gasket device for mounting a brake drum in a brake and wheel assembly, this device being flat, simple in its construction and relatively inexpensive as well as being adapted for mounting between an annular attachment surface of a wheel assembly and an inner surface of the brake drum. This gasket device also helps to prevent corrosion at the attachment surface between the wheel assembly and the brake drum and permits easy removal of the brake drum when this is required for brake servicing or other reasons.

### SUMMARY OF THE INVENTION

According to one aspect of the invention, a gasket device for use on a brake drum or wheel hub comprises an annular, flat gasket seal made of thin, flat, flexible polyethylene material. This gasket seal has a circular outer periphery with a first diameter corresponding substantially to the diameter of an annular attachment surface of the brake drum or hub on which the gasket device is to be used. The gasket seal also has a circular central opening with a second diameter corresponding substantially to the diameter of a central cylindrical extension adjacent the brake drum or hub and a plurality of small openings for snugly accommodating wheel studs on the brake drum or hub, each of which can pass through a respective one of the small openings during use of the gasket device. This gasket device is adapted for mounting in a sealing manner between the brake drum or hub and a central mounting portion of a vehicle wheel and is capable of conforming to an adjacent back surface of the central mounting portion of the wheel when the gasket device is used.

Preferably the gasket seal has a substantially uniform thickness which is less than 0.1 inch and the small openings in the device have a uniform diameter which does not exceed about ⅝^{th} inch.

According to another aspect of the invention, a vehicle wheel and hub assembly combination includes a vehicle wheel having an annular rim and an annular connecting section extending radially inwardly from the rim and rigidly connected thereto. The connecting section has a plurality of stud-receiving holes therein spaced inwardly from the rim and spaced evenly and circumferentially about the wheel. The hub assembly includes a rotatable, radially extending, annular attachment surface and wheel studs extending from the attachment surface in an axial direction relative to a central axis about which the wheel is adapted to rotate. There is also a circular, central cylindrical extension projecting axially outwardly from the center of the attachment surface and this extension has an outer circumference spaced radially inwardly from the wheel studs. An annular, flat, flexible gasket seal made of flat polyethylene material is also provided and this gasket seal has a substantially circular outer periphery with a diameter corresponding substantially to the outer diameter of the attachment surface. The gasket seal also has a substantially circle central opening with a diameter corresponding closely to the diameter of the central cylindrical extension. The gasket seal is formed with a plurality of small openings snugly and respectively accommodating the wheel studs, each of which passes through a respective one of the small openings and a respective one of the stud-receiving holes. Wheel nuts detachably connect the vehicle wheel to the hub assembly by means of the wheel studs with the gasket seal tightly clamped between the connecting section and the attachment surface. The gasket seal has a shape that conforms closely to an adjacent contact surface of the connecting section of the wheel.

In one preferred embodiment of this combination, the hub assembly includes a disk brake assembly and has a wheel hub, a calliper with a brake pad, and a brake disk carried by the hub and spaced axially inboard from the connecting section of the wheel.

According to a further aspect of the invention, a gasket device for mounting a brake drum in a wheel hub assembly for a vehicle comprises an annular, flat gasket seal made of thin, flexible polyethylene material and having a circular outer periphery with a first diameter corresponding substantially to an outer diameter of a drum mounting flange of the wheel hub assembly on which the gasket device is to be used. The gasket seal also has a circular central opening with a second diameter substantially less than the first diameter and a plurality of small openings for snugly accommodating wheel studs of the wheel hub assembly, each of which can pass through a respective one of the small openings during use of the gasket device. The gasket device is adapted for mounting between the mounting flange of the wheel hub assembly and an inner surface of the brake drum that extends radially relative to a central axis of rotation of the brake drum when the gasket device is used.

In a preferred form of this gasket seal, it has a substantial uniform thickness which is less than 0.1 inch and is able to conform to the inner surface of the brake drum when the gasket device is used.

According to still another aspect of the invention, there is provided a vehicle wheel and drum brake combination that includes a vehicle wheel having an annular rim and an annular connecting section extending radially inwardly from the rim and rigidly connected thereto. The connecting section has a plurality of stud-receiving holes therein spaced inwardly from the rim and spaced evenly and circumferentially about the wheel. There is also a drum brake assembly including a hollow brake drum member, a brake shoe mechanism located in the brake drum member, and a rotatable drum mounting hub flange. A plurality of wheel studs are rigidly secured to the hub flange and extend in an axial direction relative to a central axis about which the hub flange and brake drum member are adapted to rotate. A flat gasket seal made of flexible, plastics material and having a substantially circular outer periphery is also included in the combination. This gasket seal has an outer diameter which does not exceed an outer diameter of the hub flange and a plurality of small openings for snugly accommodating the wheel studs, each of which passes through a respective one of the small openings and a respective one of the stud-receiving holes. There are also wheel nuts detachably connecting the brake drum and the vehicle wheel to the hub flange with the gasket seal tightly clamped between the hub flange and an inner surface of the brake drum.

In a preferred form of this combination, the gasket seal is made of flexible polyethylene of sufficiently high density that it can absorb heat from the brake drum during use of the combination without being significantly damaged.

Further features and advantages and preferred embodiments of gasket devices constructed in accordance with the invention and vehicle wheel and hub combinations which include such devices will become apparent from the following detailed description taken in conjunction with the drawings.

### BRIEF DESCRIPTION OF THE DRAWINGS

FIG. 1 is a front view of a gasket device constructed in accordance with the invention;

FIG. 2 is an edge view of the gasket device of FIG. 1;

FIG. 3 is a front view of a drum brake assembly with the drum removed to show major internal components and showing a gasket device of the invention mounted on the brake assembly and partially broken away;

FIG. 4 is a front view of a brake drum assembly with the drum in place and a gasket device of the invention mounted on a wheel attachment surface of the drum;

FIG. 5 is a rear view of a standard brake drum with holes for receiving the wheel studs;

FIG. 6 is a front view of a standard disk brake fitted with a gasket device of the invention, this device shown only in part for purposes of illustration;

FIG. 7 is a side elevation of a standard disk brake fitted with the gasket device on the wheel attachment surface;

FIG. 8 is an exploded view showing the major components of a vehicle wheel and brake combination and the gasket device of the invention for mounting between the vehicle wheel and the brake assembly; and

FIG. 9 is a partial cross-section taken along the central axis of a vehicle wheel and showing portions of the wheel, a disk brake connected thereto, and a gasket device of the invention.

### DETAILED DESCRIPTION OF PREFERRED EMBODIMENTS

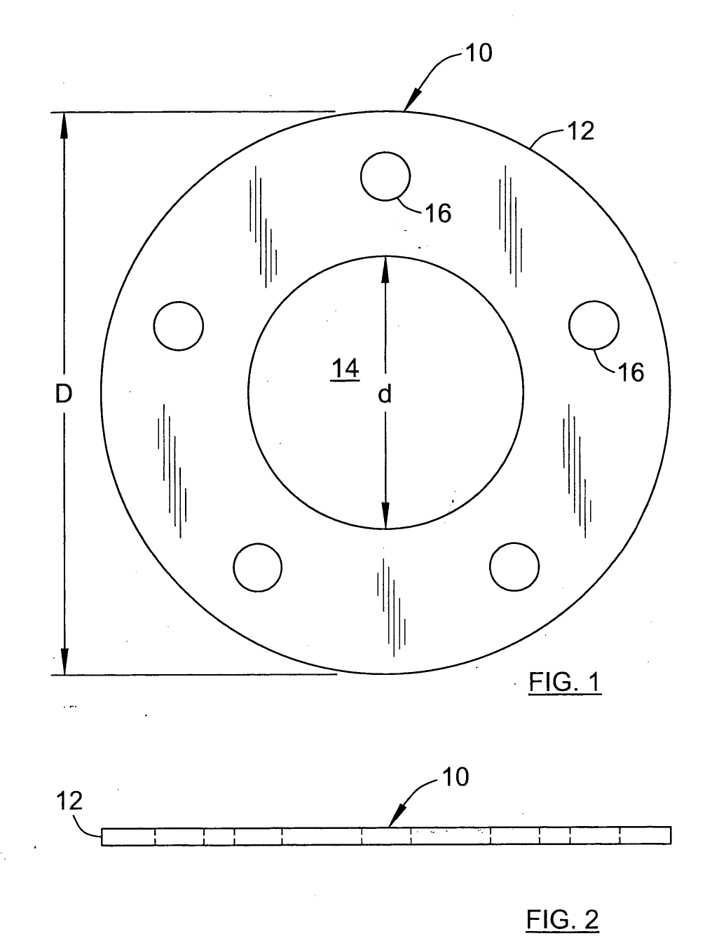

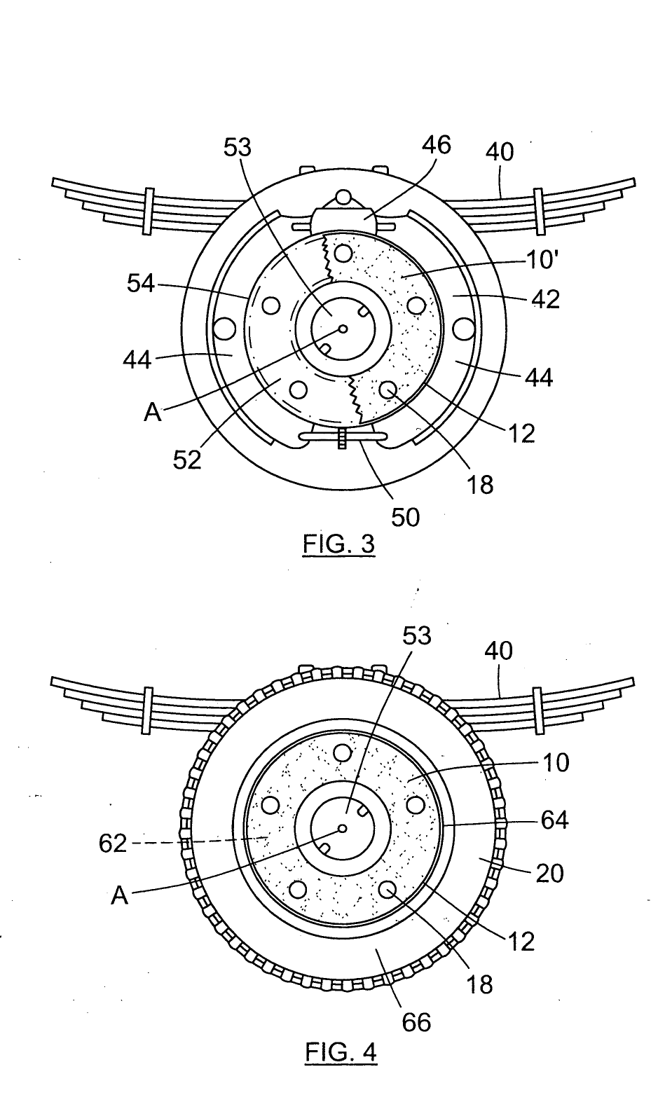

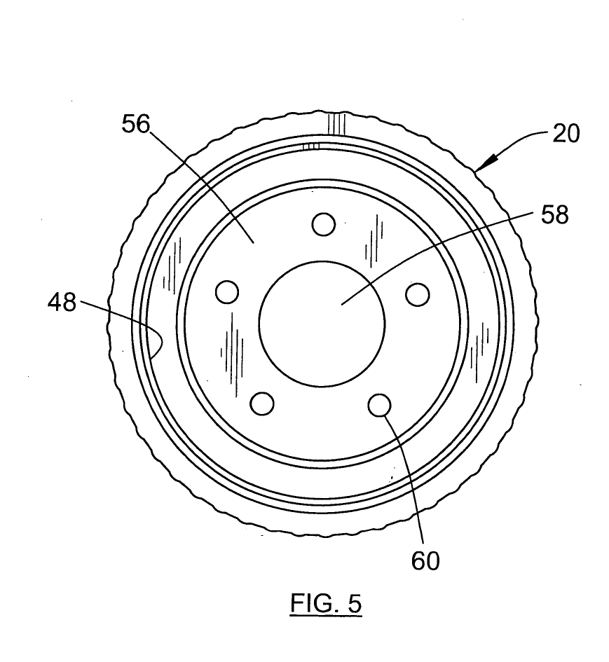

FIGS. 1 and 2 illustrate a preferred form of gasket device 10 constructed in accordance with the invention. As explained further hereinafter, the gasket device 10 can include two different embodiments which can be used at two different locations in a vehicle wheel and hub combination. The first embodiment of this gasket device is for use on a brake drum where the vehicle wheel and brake combination includes a drum brake assembly or on a wheel hub where the vehicle wheel and hub combination includes a disk brake. The second embodiment of the gasket device is made for use in a wheel hub assembly that includes a drum brake and it is not used in conjunction with disk brakes. Also, in the case where the vehicle wheel and brake combination includes a drum brake assembly, the first embodiment of the gasket device can be used together with the second embodiment of the gasket device as will become clear from the following description. FIGS. 1 and 2 illustrate the general configuration and arrangement of both embodiments of the gasket device which comprises an annular, flat gasket seal made of a thin, flat, flexible plastics material, preferably polyethylene. In addition to having the required flexibility and ability to conform to an adjacent, hard metal surface when clamped thereto, polyethylene has the additional advantage of being relatively inexpensive. The gasket device has a circular outer periphery 12 having a first diameter D. The gasket-seal also has a circular central opening 14 with a second diameter d. The gasket device is formed with a plurality of small openings 16 which are preferably circular and are sized to snugly accommodate wheel studs 18 (see FIGS. 3 and 4) provided on the brake drum or hub. Each wheel stud 18 can pass through a respective one of the small openings 16 during use of the gasket device. The gasket seal 10 preferably has a substantial uniform thickness which is less than 0.1 inch and, in one preferred embodiment, is 0.047 inch or about 0.05 inch (rounded off).

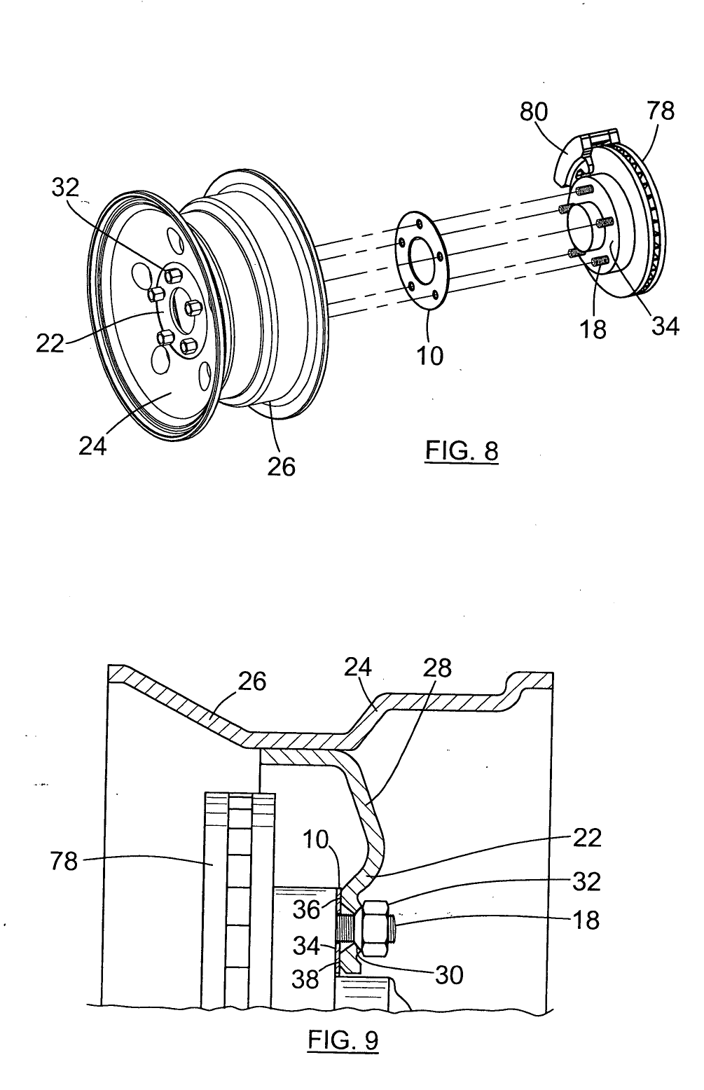

The first embodiment of the gasket device is for mounting in a sealing manner between the brake drum indicated at 20 in FIGS. 4 and 5 and a central mounting portion 22 of a standard vehicle wheel 24. Although a complete steel or metal alloy wheel 24 is shown in FIG. 8 in combination with a disk brake assembly, it will be appreciated by those skilled in the art that a similar vehicle wheel can also be mounted on the brake drum 20 illustrated in FIGS. 4 and 5. The vehicle wheel 24 is shown without a rubber tire mounted thereon and it will be appreciated that the complete vehicle wheel when ready for use includes a rubber tire which can be of standard construction, this tire being mounted on an annular rim 26 which is shaped to hold the inflatable tire. Connected to the inside of the rim is an annular connecting section 28, sometimes referred to as a spider. This connecting section extends radially inwardly from the rim and is rigidly connected thereto, such as by welding. This connecting section has a plurality of stud-receiving holes 30 formed therein and spaced inwardly from the rim. The holes 30 are spaced evenly and circumferentially about the wheel 24. Also shown in FIGS. 8 and 9 are a plurality of wheel nuts 32 which can be of standard configuration. These nuts, five of which are shown in FIG. 8, are used to detachably connect the vehicle wheel 24 to the hub assembly by means of the wheel studs 18. At the same time, the first embodiment of the gasket device 10 of the invention is tightly clamped between the connecting section of the wheel and a rotatable, radially extending annular attachment surface of the hub assembly. With the disk brake assembly of FIGS. 8 and 9, this annular attachment surface is the flat, annular surface 34. Because of the flexible nature of the flat gasket seal 10, when the seal is used, its shape conforms to an adjacent contact surface or contact surfaces 36, 38 of the connecting section 28 of the wheel and thereby forms a good protective seal.

In the gasket device 10 shown in FIG. 1, there are five of the small openings 16 distributed evenly and circumferentially around the gasket seal. It will be appreciated that it is possible, particularly for a small wheel assembly for there to be fewer than five openings 16 and it is also possible, particularly in the case of large wheel assemblies such as those used for trucks, for there to be more than five openings 16 to accommodate more than five wheel studs. Also, it will be appreciated that the other diameter D of the gasket device can vary depending upon the brake assembly with which it is to be used. However, in one preferred embodiment of the gasket device 10, the outer diameter (sometimes referred to herein as the first diameter) is less than eight inches and in one particular embodiment, is slightly less than seven inches.

The use of the gasket device of the invention will now be described with particular reference to FIGS. 3 to 5 which illustrate the use of the device in combination with a drum brake and hub assembly which is only shown schematically and without the usual springs for ease of illustration. The drum brake and hub assembly and vehicle axle are shown supported by a leaf spring arrangement 40 of standard construction. It will be understood by those skilled in the art that instead of the illustrated leaf spring, it is also possible to support the axle, brakes and wheels by means of a coil spring generally used in combination with a suitable shock absorber.

In FIG. 3, the drum brake and hub assembly is shown with the brake drum removed so that the internal components can be seen. These components include a standard brake shoe mechanism 42 which normally includes two arc-shaped brake shoes 44. As is well known, when the user of the vehicle hits the pedal, pistons in a brake cylinder 46 push the brake shoes 44 so that they engage the cylindrical, interior surface of the brake drum 20, this surface being indicated at 48 in FIG. 5. The illustrated, standard drum brake and hub assembly also includes an adjuster mechanism 50 and can also include an emergency brake mechanism (not shown). The brake assembly further includes a rotatable drum mounting hub flange 52 which has a circular outer circumference located at 54. A plurality of wheel studs 18 are rigidly secured to this hub flange and, in the illustrated embodiment, there are five of these studs. In one preferred embodiment of this brake and hub assembly, these studs have a diameter of ⅝^{th} inch. The studs extend in an axial direction relative to a central axis located at A about which the hub flange and drum member are adapted to rotate together with the axle 53.

FIG. 3 illustrates the use of the second embodiment of the gasket device constructed in accordance with the invention. This second embodiment as indicated has the annular configuration and shape illustrated generally in FIGS. 1 and 2 and it is shown only partially in FIG. 3 for sake of illustration. In order to differentiate this second embodiment, it is indicated by reference 10′ in FIG. 3. As with the first embodiment, this second embodiment is also a flat gasket seal made of flexible plastics material, preferably flexible polyethylene. In the case of a gasket seal 10′ made of polyethylene, the polyethylene should have a sufficiently high density that it can absorb heat from the brake drum and the other major components of the brake during use of the brake without being significantly damaged. One particular high density polyethylene that is suitable for this purpose is a black polyethylene sold by Canusa-CPS North America having an office in Huntsville, Ontario, this polyethylene being identified by Serial No. 9019.0503109003 2203 MD0 50% 031T 900 W BK.

Also, as can be seen in FIG. 3, the outer periphery 12 of the gasket seal 10′ has an outer diameter which does not exceed an outer diameter of the mounting hub flange 52. In a preferred embodiment of the gasket seal 10′, the circular outer periphery of the gasket seal has an outer diameter which is close to or the same as the outer diameter of the mounting hub flange.

The gasket seal 10′ shown in FIG. 3 preferably has a substantially uniform thickness which is less than 0.1 inch and this gasket seal is able to conform to the inner surface 56 of the brake drum (see FIG. 5). Generally, the inner surface 56 is a flat surface with a circular outer circumference and this surface extends around a central opening 58 formed in the brake drum. In a particularly preferred embodiment of the gasket seal 10′, this gasket seal has a thickness of about 0.05 inch.

It is advantageous that the outer diameter of the gasket seal 10′ not exceed the outer diameter of the hub flange 52. The reason for this is that if the outer diameter of the gasket seal does not exceed that of the hub flange, then the gasket seal 10′ has its entire annular surface clamped between the hub flange and the inner surface of the brake drum. It thus becomes unlikely that outer edge sections of the gasket seal could eventually become detached from the remainder of the gasket seal and thereby possibly foul or damage the working mechanisms of the brake. If the gasket seal 10′ exceeded the diameter of the hub flange 52, then outer edge sections of the gasket seal could possibly become detached from the remainder of the gasket seal, particularly after repeated and lengthy use of the wheel assembly and this is undesirable from the standpoint of long brake life and proper brake operation.

Turning now to FIG. 4 which illustrates the brake drum mounted in place on the hub flange 52, it will be understood that the wheel studs 18 extend through respective holes 60 formed in the radially extending side of the brake drum. When the vehicle wheel and brake combination includes a drum brake assembly, the first-embodiment of the gasket device 10 as described above can be mounted on the radially extending side of the brake drum as shown in FIG. 4. In this position, the gasket seal 10 can be clamped between the brake drum member 20 and the aforementioned connecting section 28 of the vehicle wheel (which can be similar to that shown in FIGS. 8 and 9). As shown in FIG. 4, the gasket seal 10 preferably has a substantially circular outer circumference at 12 which corresponds substantially to an annular, outer attachment surface 62 of the brake drum. The circular outer edge 64 of this attachment surface can be seen in FIG. 4. The wheel studs 18 project outwardly through the attachment surface 62 as shown and, in addition, they project through the small holes 16 of the gasket seal 10. It will be understood that the attachment surface 62 can project a short distance from the remaining annular side wall 66 of the brake drum. For this reason, some air is able to circulate between the inside of the vehicle wheel and the brake drum during use of the brake and wheel combination. Because the first embodiment of the gasket seal 10 normally encounters lower operating temperatures than the second embodiment 10′, the first embodiment 10 can be made of a polyethylene material which is less dense than the polyethylene used for the gasket seal 10′ shown in FIG. 3. A suitable polyethylene for the first embodiment 10 of the gasket seal is that sold by Canusa-CPS North America of Huntsville, Ontario, under Serial No. 9012.0503109003 1012 MD0 50% 031T 900 W YE. This polyethylene material can generally be described as a medium density polyethylene.

It will be appreciated that in the preferred vehicle wheel and drum brake combination, both the first embodiment of the gasket seal 10 and the second embodiment 10′ are used in or on the drum brake and hub assembly. In one particularly preferred version employing both gasket seals, both the gasket seals have an outer diameter which is less than eight inches and the small holes 16 in each of the seals have a uniform diameter which does not exceed ⅝^{th} inch. In fact, in a particularly preferred embodiment of both gasket seals, the diameter of each small hole in the seal corresponds to the diameter of each wheel stud, that is, ⅝^{th} inch. Although less preferred, it will be appreciated by those skilled in the art that it is possible to use only one of the two described gasket seals in a vehicle wheel and drum brake combination, that is, either the second embodiment 10′ used inside the brake drum, or the first embodiment 10 of the gasket seal used on the outside of the brake drum between the side of the brake drum and the vehicle wheel. In other words, a particular vehicle user may decide to use only one of these gasket seals in the area of the vehicle wheel and drum brake combination where it is felt or perceived that corrosion of the brake assembly may be a particular problem.

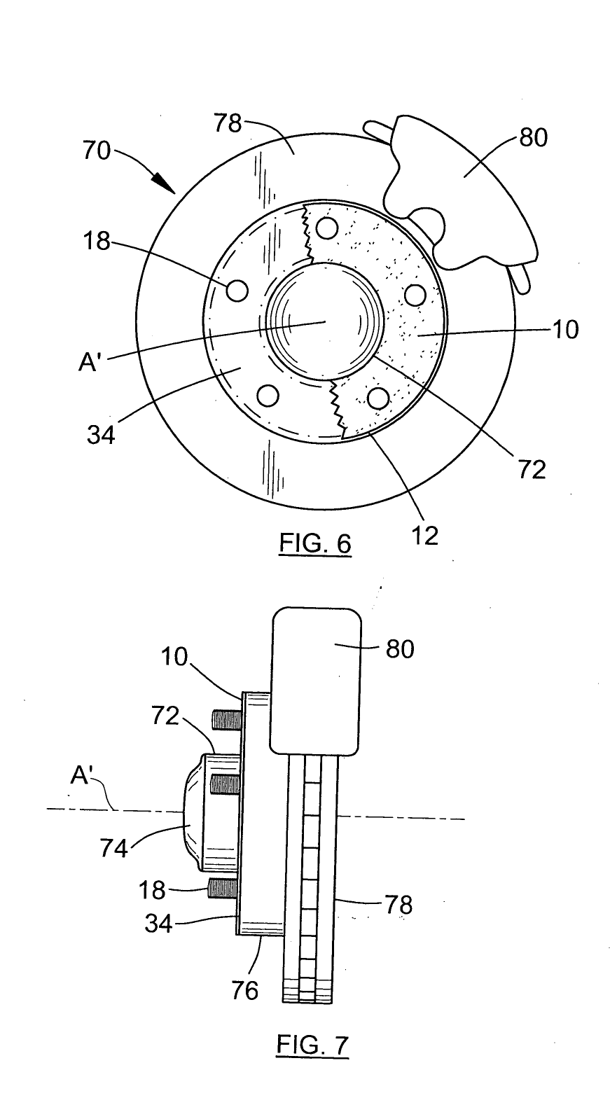

Turning now to FIGS. 6 and 7 of the drawings, these drawings as well as FIGS. 8 and 9, illustrate the use of the present gasket device 10 on a disk brake assembly indicated generally at 70. As a preliminary matter, it is noted that in a vehicle wheel and disk brake combination, there is no need for the second embodiment of the gasket device, that is the embodiment 10′, since there is no brake drum. The disk brake assembly includes the aforementioned rotatable, radially extending annular attachment surface 34 and the wheel studs 18 of which five are shown. As in the combination employing a drum brake and hub assembly, the wheel studs 18 in the disk brake assembly extend from the attachment surface 34 in an axial direction relative to a central axis A′ about which the wheel is adapted to rotate. This brake and hub assembly also has a circular, central cylindrical extension 72 projecting axially outwardly from the center of the attachment surface 3. This cylindrical extension 72 has an outer circumference spaced radially inwardly from the wheel studs 18. A circular metal dust cap 74 is mounted on the end of the cylindrical extension.

The attachment surface 34 is formed on the outer end of wheel hub 76 which has a short cylindrical exterior. A standard brake disk 78 is carried by the hub in a space axially inboard from the connecting section 28 of the wheel. Located on one side of the brake disk is a calliper 80 with the usual brake pad. As the calliper and brake disk are of standard construction, a detailed description herein is deemed unnecessary.

It will be seen that the first embodiment of the gasket device 10 has a circular outer periphery with a diameter corresponding substantially to the diameter of the annular attachment surface 34 of the wheel hub on which the gasket device 10 is to be used. This feature, together with other features of the gasket device 10 combine to make the gasket device a very good, protective seal that prevents corrosion of the hub at the attachment surface. Also, as shown in FIG. 6, the diameter of the circular central opening 14 in the gasket seal corresponds substantially to the diameter of the cylindrical extension 72 adjacent the brake hub. This inner diameter also contributes to the sealing effectiveness of the gasket seal 10 and its ability to guard against corrosion of the hub. In one preferred embodiment of this wheel assembly, the cylindrical extension 72 meets the attachment surface 34 at a curved annular shoulder. The inner diameter of the gasket seal is preferably adjusted so that the gasket seal covers the curved shoulder, at least partially. In one embodiment for example, the inner diameter is made 1/32^{nd} of an inch smaller so that it can fill the space created between the curved shoulder and the wheel when the latter is attached.

From the above description and the accompanying drawings, it will be appreciated that use of the first embodiment 10 of the gasket seal prevents bonding of the steel or alloy wheel to the brake drum or the wheel hub that may arise due to corrosion caused by water or salt coming into contact with the wheel and brake assembly. Thus, with the use of the first embodiment 10 of the gasket seal, removal of the wheel is made easier and this in turn can prevent damage to either the wheel assembly or the tire that may result from previously used wheel removal methods. With the use of the second embodiment of the gasket seal, brake drum removal is generally easier and less likely to result in damage to the drum brake and hub assembly. Moreover, the present gasket seals are relatively inexpensive to make and they are easy to install.

Although use of the first embodiment 10 of the gasket seal has been described above in connection with a wheel assembly having a drum or disk brake, it will be appreciated that this gasket seal can also be used in a wheel assembly having no brake components, for example in a wheel assembly for a non-motorized vehicle such as a boat or recreational trailer. Again the gasket seal can be used to mount the vehicle wheel to a wheel hub in a sealing manner that effectively prevents corrosion of the hub flange on which the central portion of the wheel is mounted.

It will be readily apparent to those skilled in the construction of vehicle wheel assemblies and brake assemblies, including drum brakes and disk brakes, that various modifications and changes can be made to the described and illustrated gasket devices and wheel and brake combinations without departing from the spirit and scope of this invention. Accordingly, all such modifications and changes as fall within the scope of the appended claims are intended to be part of this invention.

1. A gasket device for use on a brake drum or wheel hub, said gasket device comprising an annular, flat gasket seal made of thin, flat, flexible, polyethylene material and having a circular outer periphery with a first diameter corresponding substantially to the diameter of an annular attachment surface of said brake drum or hub on which said gasket device is to be used, said gasket seal also having a circular central opening with a second diameter corresponding substantially to the diameter of a central cylindrical extension adjacent said brake drum or hub and a plurality of small openings for snugly accommodating wheel studs on said brake drum or hub, each of which can pass through a respective one of said small openings during use of said gasket device,
wherein said gasket device is adapted for mounting in a sealing manner between said brake drum or hub and a central mounting portion of a vehicle wheel and is capable of conforming to an adjacent back surface of said central mounting portion of the wheel when said gasket device is used.

2. A gasket device according to claim 1 wherein said gasket seal has a substantially uniform thickness which is less than 0.1 inch.

3. A gasket device according to claim 1 wherein there are five or fewer of said small openings distributed evenly and circumferentially around said gasket seal.

4. A gasket device according to claim 3 wherein said small openings have a uniform diameter which does not exceed about ⅝^{th} inch.

5. A gasket device according to claim 3 wherein said first diameter of the gasket seal is less than 8 inches and said polyethylene material has a medium density.

6. A vehicle wheel and hub combination comprising:
a vehicle wheel including an annular rim and an annular connecting section extending radially inwardly from said rim and rigidly connected thereto, said connecting section having a plurality of stud-receiving holes therein spaced inwardly from said rim and spaced evenly and circumferentially about said wheel;
a wheel hub assembly including a rotatable radially extending, annular attachment surface, wheel studs extending from said attachment surface in an axial direction relative to a central axis about which said wheel is adapted to rotate, and a circular central cylindrical extension projecting axially outwardly from the center of said attachment surface, said cylindrical extension having an outer circumference spaced radially inwardly from said wheel studs;
an annular, flat, flexible gasket seal made of flat polyethylene material having a substantially circular outer periphery with a diameter corresponding substantially to the diameter of said attachment surface and also a substantially circular central opening with a diameter corresponding closely to the diameter of said central cylindrical extension, said gasket seal being formed with a plurably of small openings snugly and respectively accommodating said wheel studs each of which passes through a respective one of said small openings and a respective one of said stud-receiving holes;
and wheel nuts detachably connecting said vehicle wheel to said wheel hub assembly by means of said wheel studs with said gasket seal tightly clamped between said connecting section and said attachment surface,
wherein said gasket seal has a shape that conforms to an adjacent contact surface of said connecting section of the wheel.

7. A combination according to claim 6 wherein said wheel hub assembly includes a wheel hub and a disk brake having a calliper with a brake pad and a brake disk carried by wheel hub and spaced axially inboard from said connecting section of the wheel.

8. A combination according to claim 6 wherein said wheel hub assembly includes a drum brake having a rotatable brake drum on which said attachment surface is provided.

9. A combination according to claim 6 wherein said gasket seal has a substantially uniform thickness which is about 0.05 inch.

10. A combination according to claim 6 wherein said small openings have a uniform diameter which does not exceed ⅝^{th} inch and the diameter of the outer periphery of said gasket seal and of the annular attachment surface is less than 8 inches.

11. A combination according to claim 8 including a second annular, flexible gasket seal mounted in said wheel hub assembly against an inner side of said brake drum and spaced axially inwardly from said connecting section of the wheel, said second gasket seal having a substantially circular outer periphery, a substantially circular central opening with a diameter corresponding closely to said diameter of said central cylindrical extension, and a plurality of small openings snugly and respectively accommodating said wheel studs which pass therethrough.

12. A combination according to claim 11 wherein said second gasket seal is made of thin, flat polyethylene material.

13. A combination according to claim 12 wherein said second gasket seal is made of higher density polyethylene than the first mentioned gasket seal and has a thickness less than 0.1 inch.

14. A gasket device for mounting a brake drum in a brake and wheel assembly for a vehicle, said gasket device comprising an annular, flat gasket seal made of thin, flexible polyethylene material and having a circular outer periphery with a first diameter corresponding substantially to an outer diameter of a drum mounting hub flange of said brake and wheel assembly on which said gasket device is to be used, said gasket seal also having a circular central opening with a second diameter substantially less than said first diameter and a plurality of small openings for snugly accommodating wheel studs of said brake and wheel assembly each of which can pass through a respective one of said small openings during use of said gasket device,
wherein said gasket device is adapted for mounting between said hub flange of said brake and wheel assembly and an inner surface of said brake drum that extends radially relative to a central axis of rotation of the brake drum when said gasket device is used.

15. A gasket device according to claim 14 wherein said gasket seal has a substantially uniform thickness which is less than 0.1 inch and is able to conform to said inner surface of said brake drum when said gasket device is used.

16. A gasket device according to claim 15 wherein said small openings have a uniform diameter which does not exceed ⅝^{th} inch.

17. A gasket device according to claim 15 wherein said polyethylene material has a sufficiently high density that it can absorb heat from said brake drum during use of said brake and wheel assembly without being significantly damaged.

18. A vehicle wheel and drum brake combination comprising:
a vehicle wheel including an annular rim and an annular connecting section extending radially inwardly from said rim and rigidly connected thereto, said connecting section having a plurality of stud-receiving holes therein spaced inwardly from said rim and spaced evenly and circurnferentially about said wheel;
a drum brake and hub assembly including a hollow brake drum member, a brake shoe mechanism located in said brake drum member, a rotatable drum mounting hub flange, and a plurality of wheel studs rigidly secured to said hub flange and extending in an axial direction relative to a central axis about which said hub flange and brake drum member are adapted to rotate;
a flat gasket seal made of flexible plastics material and having a substantially circular outer periphery with an outer diameter which does not exceed an outer diameter of said hub flange and a plurality of small openings for snugly accommodating said wheel studs, each of which passes through a respective one of said small openings and a respective one of said stud-receiving holes; and
wheel nuts detachably connecting said brake drum member and said vehicle wheel to said hub flange with said gasket seal tightly clamped between said hub flange and an inner surface of said brake drum.

19. A vehicle wheel and drum brake combination according to claim 18 wherein said gasket seal is made of flexible polyethylene of sufficiently high density that it can absorb heat from said brake drum during use of said combination without being significantly damaged.

20. A vehicle wheel and drum brake combination according to claim 19 wherein said gasket seal has a substantially uniform thickness which is less than 0.1 inch and conforms to said inner surface of said brake drum.

21. A vehicle wheel and drum brake combination according to claim 20 wherein said gasket seal has a thickness which is about 0.05 inch.

22. A vehicle wheel and drum brake combination according to claim 19 including a second annular, flexible gasket seal clamped between said brake drum member and said connecting section of said vehicle wheel, said second gasket seal having a substantially circular outer circumference with a diameter corresponding substantially to an annular outer attachment surface of said brake drum and a plurality of small holes for accommodating said wheel studs which project outwardly from said outer attachment surface of said brake drum and through said small holes.

23. A vehicle wheel and drum brake combination according to claim 22 wherein said second gasket seal is made of a polyethylene material which is less dense than the polyethylene used for the first mentioned gasket seal.

24. A vehicle wheel and drum brake combination according to claim 23 wherein both gasket seals have an outer diameter which is less than 8 inches and said small openings and small holes both have uniform diameters which do not exceed ⅝^{th} inch.
